(19) United States
(12) Patent Application Publication
(10) Pub. No.: US 2011/0121734 A1
(43) Pub. Date: May 26, 2011

(54) LIGHT EMITTING DIODE (LED) BEACON

(76) Inventor: Ryan Bernard Pape, Southington, CT (US)

(21) Appl. No.: 12/953,796

(22) Filed: Nov. 24, 2010

Related U.S. Application Data
(60) Provisional application No. 61/264,403, filed on Nov. 25, 2009.

(51) Int. Cl. H05B 37/02; F21V 7/00; F21V 7/06

(52) U.S. Cl. 315/86; 362/235; 315/297; 315/360; 315/294; 362/341

(57) ABSTRACT

A beacon for use at transportation hubs, such as airports, heliports, and marine vessels and for marking aviation obstructions. The beacon is modular in design and has a substantially cylindrical housing that includes a bottom portion, a window and a top portion, sealed by gaskets. The beacon is configured for outdoor use and is explosion-proof or, at least, explosion-resistant. The housing defines a cavity that abuts the window. A reflector and a light source, such as a light emitting diode (LED) or an array of LEDs, are mounted in the cavity of the housing. The beacon includes a control unit with a GPS transceiver unit and another control inlet/outlet. Using the control unit, the beacon can operate individually or in a coordinated manner with other beacons.

### PRIORITY CLAIM OR CROSS REFERENCE TO RELATED CASE

The present application claims the benefit of provisional U.S. Patent Application Ser. No. 61/264,403 filed on Nov. 25, 2009, which is hereby incorporated by reference.

### FIELD OF THE INVENTION

The present invention relates to a light emitting diode (“LED”) beacon for transportation hubs. In particular, the present invention relates to a versatile programmable LED beacon capable of variable output signals and modes for aviation obstruction, heliport and marine vessel environments.

### BACKGROUND OF THE INVENTION

The use of flashing beacons as aids to air navigation dates to the beginning of commercial aviation in the 1920's. Beacons mark obstructions to air navigation, mark the locations of landing facilities and warn pilots of hazardous conditions.

As transportation routes and facilities become more numerous and diverse, more complex combinations of signals have come into play. There is a need for more versatile and capable beacons that can perform a broader range of roles with greater responsiveness to user demands and controls.

Traditional beacons rely on incandescent light sources. Existing traditional incandescent beacons lack versatility, precision of signal and energy efficiency. The incandescent beacons are also inefficient from an energy consumption standpoint and are, thus, not environmentally friendly.

Some existing beacons use single application LED technologies. The existing LED beacons lack versatility and precision, like the traditional incandescent beacons. Further, the LED beacons rely on plastic lens and housing designs that are susceptible to ultraviolet light degradation over a short period of time relative to the long life of the LED light source. The LED beacons lack a robust mechanical design.

The object of the present invention is, therefore, to provide an improved beacon, which, among other desirable attributes, significantly reduces or overcomes the above-mentioned deficiencies of prior beacons.

### SUMMARY OF THE INVENTION

Accordingly, the present invention provides a modular beacon having a housing that includes a bottom portion, a window and a top portion. The housing defines a cavity abutting the window and is sealed by gaskets. The housing is formed of cast aluminum and glass. The metallic components are powder-coated for corrosion resistance and may be marine treated using special techniques. The glass is made of strong soda-lime glass.

It is an object of the present invention to provide a beacon that is configured for outdoor use in hazardous atmosphere locations and is explosion-proof or, at least, explosion-resistant.

In an aspect of the present invention, a beacon is provided having a housing that defines a cavity and a reflector and a light source aligned with the reflector that are disposed in the cavity. The light source is a light emitting diode (LED) or an array of LEDs. The light source can emit light that is visible from any direction of approach and on any landing heading. Preferably, the reflector is configured to reflect light from the light source in a light pattern based on the intended use of the beacon, such as a circular parabolic reflector for omnidirectional light transmission.

In an aspect of the present invention, a beacon is provided that is configured with programming that instructs the beacon to flash one or more colors of light sequentially at a range of intensities. Preferably, the light source emits aviation colors, including white (clear), green, yellow, blue, infrared (IR) and red, at between 700 and 2,500 candelas during normal operation.

In an aspect of the present invention, a beacon is provided with a light source having a dimmer option. The dimmer option, which can be manually or remotely activated, reduces the intensity of emitted light to a low level for a period of time before reverting to normal operating conditions. Preferably, the dimmer option reduces the intensity of the light to below 60 candelas.

In an aspect of the present invention, a beacon is provided that is configured with programming that instructs the beacon to emit light according to numerous transmission schemes. It is an object of the present invention to provide a beacon that is configured to transmit Morse Code signals.

In an aspect of the present invention, a beacon is provided that is configured with programming that instructs the beacon to emit light in a light pattern that mimics a rotating light fixture. The beacon, which has an array of LEDs as the light source, mimics a rotating light fixture by illuminating the array of LEDs separately in sequence (or quasi-sequence) to create a shifting beam of light. It is another object of the present invention to provide a beacon that is configured with programming that instructs the beacon to illuminate the array of LEDs in sequence at varying intensity levels to smooth the edges of the shifting beam of light created thereby. It is an object of the present invention to provide the beacon with a multi-colored array of LEDs, the beacon mimicking a multicolor rotating light fixture.

In an aspect of the present invention, a beacon is provided having a control unit that includes a surge protection unit, a power supply unit, a backup power supply, a processing unit, a timer and a storage unit. In another aspect of the present invention, a beacon is provided with a global positioning transceiver unit that is in communication with the control unit. The global positioning transceiver unit synchronizes and coordinates multiple remote beacons (i.e., without an external controller).

Another object of the present invention is to provide a beacon or system of beacons for use on tall structures and at aviation and maritime transportation facilities and, in particular, heliports, airports and marine vessels.

According to one embodiment of the present invention, a beacon is provided for a transportation hub or the like, the beacon comprising: a housing having a window and defining a cavity abutting the window; a light source mounted in the cavity of the housing, wherein the light source comprises an array of light emitting diodes (LEDs); and a reflector mounted in the cavity of the housing and positioned to reflect light emitted by the light source toward the window.

According to another embodiment of the present invention, a status light is provided for a transportation hub or the like, the status light comprising: a cup-shaped housing having a base that includes mounting means and defining a top opening; a cup-shaped lid mounted to the housing about the top opening, wherein the lid defines a central opening; a lens mounted to the central opening of the lid; and a light source disposed within the housing, wherein the light source comprises an array of light emitting diodes (LEDs).

According to another embodiment of the present invention, a light system is provided for a transportation hub or the like, the light system comprising: two or more beacons, each of the two or more beacons comprising: a housing having a window and defining a cavity abutting the window, a light source mounted in the cavity of the housing, wherein the light source comprises an array of light emitting diodes (LEDs), and a reflector mounted in the cavity of the housing and positioned to reflect light emitted by the light source toward the window; a centralized control unit in communication with the two or more beacons; and a wireless transceiver in communication with the central control unit; wherein the wireless transceiver is selected from the group consisting of: a global positioning system (GPS) transceiver unit and a photoelectric controller unit; wherein the centralized control unit regulates the operation of the two or more beacons based at least in part on a communication signal from the wireless transceiver.

According to another embodiment of the present invention, a light system is provided for a transportation hub or the like, the light system comprising: at least one beacon, the at least one beacon comprising: a housing having a window and defining a cavity abutting the window, a light source mounted in the cavity of the housing, wherein the light source comprises an array of light emitting diodes (LEDs), and a reflector mounted in the cavity of the housing and positioned to reflect light emitted by the light source toward the window; at least one status light, the status light comprising: a cup-shaped housing having a base that includes mounting means and defining a top opening; a cup-shaped lid mounted to the housing about the top opening, wherein the lid defines a central opening; a lens mounted to the central opening of the lid; and a light source disposed within the housing, wherein the light source comprises an array of light emitting diodes (LEDs); and a centralized control unit in communication with the at least one beacon and the at least one status light; wherein the centralized control unit regulates the operation of the at least one beacon and the at least one status light.

According to another embodiment of the present invention, a beacon is provided for a transportation hub or the like, the beacon comprising: a control unit; and an array of light emitting diodes (LEDs) connected to the control unit; wherein: the control unit regulates operation of the array of LEDs; and the control unit is configured with programming to instruct the array of LEDs to emit light in Morse Code format.

These and other features of the present invention are described with reference to the drawings of preferred embodiments of a beacon. The illustrated embodiments of the beacon of the present invention are intended to illustrate, but not limit, the invention.

### BRIEF DESCRIPTION OF THE DRAWINGS

FIG. 1 illustrates a front perspective view of the basic beacon according to one embodiment of the present invention.

FIG. 2 illustrates a top view of an array of LEDs of the beacon according to FIG. 1.

FIG. 3 illustrates a side view of a light pattern emitted from a beacon according to another embodiment of the present invention.

FIG. 4 illustrates a heat shield positioned between a beacon and a heat source according to another embodiment of the present invention.

FIG. 5 illustrates a circuit diagram of the electrical components of a beacon according to one embodiment of the present invention.

FIG. 6 illustrates a reduced intensity status light or repeater light according to another embodiment of the present invention.

FIG. 7 is a schematic illustration of a network of beacons and status lights coordinated by a central control device using a photoelectric controller unit according to another embodiment of the present invention.

FIG. 8 is a schematic illustration of a network of beacons and status lights coordinated by a central control device according another embodiment of the present invention.

### DETAILED DESCRIPTION OF THE PREFERRED EMBODIMENTS

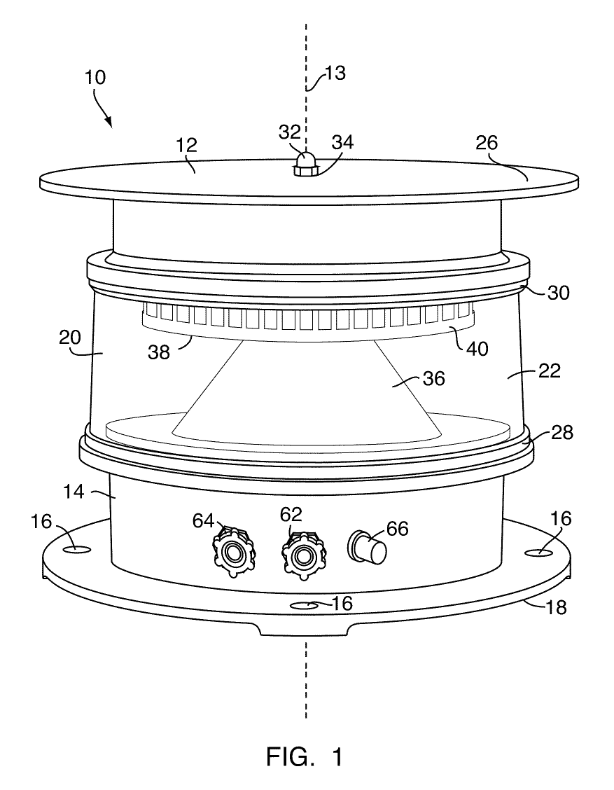

Referring to FIG. 1, a basic beacon is shown at 10. The beacon 10, which is built in the Federal Aviation Administration (“FAA”) L-864 style, is formed from modular components. In particular, the beacon 10 has a substantially cylindrical shaped housing 12, which defines a longitudinal axis 13 thereof. The housing 12 is made of or assembled from a number of modular components. The housing 12 includes a substantially cylindrical bottom portion 14 with mounting means for mounting the bottom portion 14 to a pole, building, tarmac, aviation obstruction or other support surface. As shown in FIG. 1, the mounting means includes holes 16 formed in a flange 18 extending from the bottom portion 14 for mounting the bottom portion 14 to a support surface using fasteners inserted through the holes 16. The bottom portion 14 is cast from aluminum and is powdercoated for corrosion resistance. The powdercoat can be any color, such as yellow or green.

Preferably, the bottom portion 14 is also treated for marine conditions (“marine treated”), which means that the bottom portion 14 is cleaned per U.S. Military method III of TT-C-490, chromate primed per U.S. MIL-C-5541, epoxy powder base coated and glossy polyester powder finish coated in color RAL 6003 (FED-STD-595 color #14097) green. The coats are then oven cured per U.S. MIL-PRF-24712A. The resultant coated components meet the corrosion resistance requirements of the U.S. Military Standard Salt Fog Test conducted per MIL-STD-810E, Method 529.3, Procedure 1 and FAA L-864 test requirements.

In one exemplary embodiment, the housing is approximately 304 mm (12 in) tall, 381 mm (15 in) wide and 381 mm (15 in) deep. The holes 16 are positioned 168.3 mm (6.63 in) from the center axis of the bottom portion 14 and are 17.5 mm (0.67 in) in diameter.

The housing 12 includes a window 20 that is mounted to the uppermost surface of the bottom portion 14. The window 20 is a substantially cylindrical tube of glass that, in part, defines a cavity 22 of the housing 12. In other words, the window 20 abuts the cavity 22. Preferably, the window 20 is made of transparent, strong soda-lime glass.

The housing 12 includes a top portion 24 that is mounted to the uppermost surface of the window 20. Like the bottom portion 14, the top portion 24 has a substantially cylindrical shape, includes a flange 26, is formed from cast aluminum and is treated to have corrosion resistance properties.

Lower and upper gaskets 28, 30 are disposed between the bottom portion 14 and the window 20 and between the window 20 and the top portion 24, respectively. The gaskets 28, 30 are made from silicone rubber and form a watertight seal between the modular components of the housing 12. The gaskets 28, 30 are fitted to the upper and lower edges of the window 20 to provide a moisture seal or barrier for the housing 12.

The modular components of the housing 12 are held together by a threaded rod (not shown) and self-sealing acorn nut 32. The threaded rod is inserted through a centrally disposed opening in the bottom portion 14 (i.e., along the longitudinal axis 13), the cavity 22 of the window 20 and a centrally disposed opening 34 in the top portion 24 (i.e., along the longitudinal axis 13). The acorn nut 32 is secured to a threaded tip of the threaded rod that extends beyond the uppermost surface of the top portion 24.

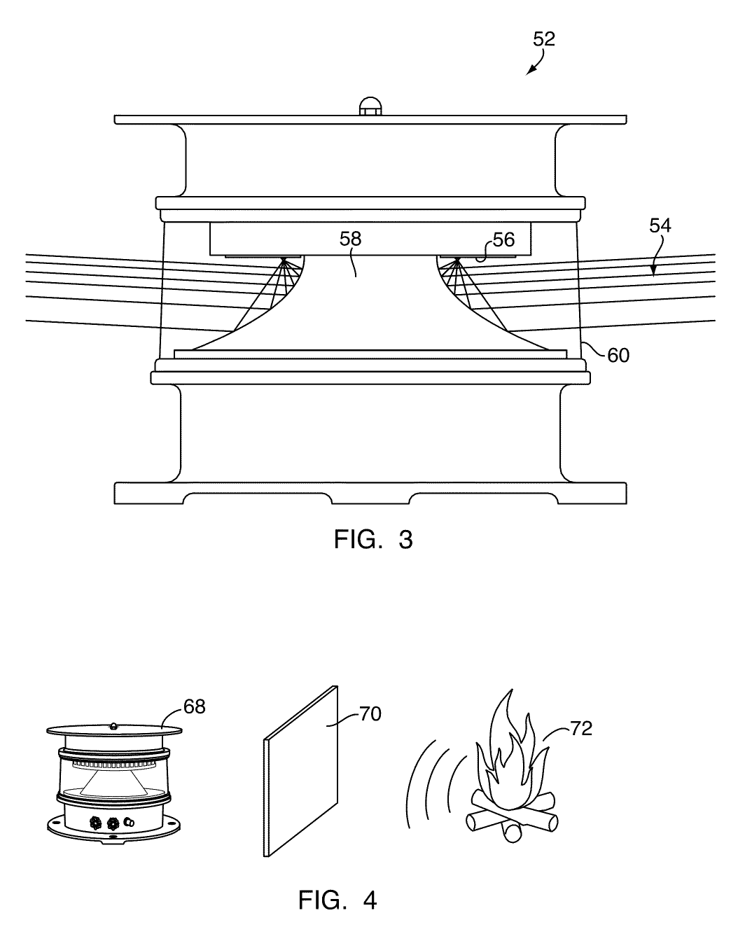

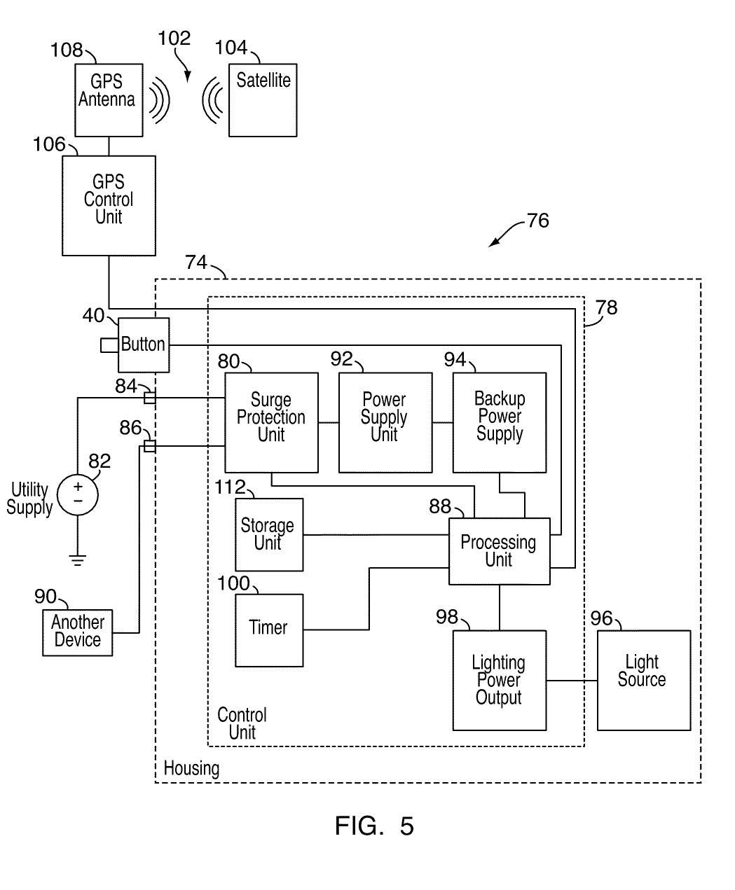

A reflector 36, a light source 38, a heatsink 40 and a control unit (see FIG. 5) are disposed in the housing 12. As seen through the window 20, the reflector 36 is a formed annular body, such as a conical section having a circular parabolic surface (see FIG. 3), that is centered about the longitudinal axis 13. The reflector 36 is mounted along an upper surface of the bottom portion 14. The reflector assembly 36 is formed from or coated by a reflective material, such as a metal, and can take on any form or shape to focus or disperse light from the LED array light source 38 in a desired light pattern (see FIG. 3).

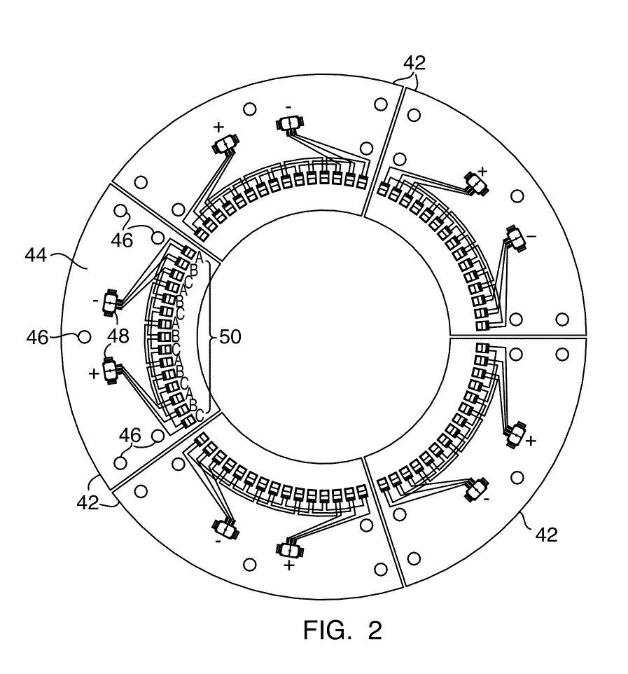

Also as seen through the window 20, the light source 38 is mounted within the heatsink 40. Referring also to FIG. 2, the light source 38 is one or more light emitting diodes (“LEDs”) or, preferably, an array of modular LED sectors 42 formed in an annular or circular pattern and centered about the longitudinal axis 13 of the housing 12. The LEDs face downward away from the top portion 26 and toward the reflector 36. The light source 38 has a substantially round flat shape.

Preferably, the light source 38 is formed of five sectors 42 each being an angular section of approximately 72°. Each sector 42 has a backing 44 that defines holes 46 therein. The sectors 42 are aligned and secured to the underside of the top portion 24 of the housing 12 by fasteners or protrusions that extend from the top portion 24 that are inserted through the holes 46.

Although it is commonly mentioned that LEDs have very long operating lives, such as 100,000 hours of continuous use, this is not the case, particularly in high demand and high intensity operating conditions. The LEDs will, in fact, degrade more rapidly and require repair and replacement. Since the light source 38 is provided in sectors 42, the light source 38 can be repaired piecemeal as each section fails. This reduces the cost of fixing the light source 38.

The backing 44 has electrodes 48, 48 mounted thereto. One side of the backing 44 has LEDs 50 mounted thereto. The electrodes 48, 48 are connected to the corresponding terminals of the LEDs 50 via conductors that activate the LEDs 50. The LEDs 50 can be organized into sets. For instance, as shown in FIG. 2, the LEDs 50 are arranged into three sets A, B, C that are capable of being activated independently of each other.

The light source 38 can emit a range of colored light in the visible and/or infrared (IR) spectrum. For instance, the sectors 42 can emit white (clear), green, yellow, blue, IR or red light, or any combination thereof.

The light source 38 can emit light at a range of intensities. For instance, the light source 38 can emit light at intensity levels of 2,500 candelas or higher. Preferably, the light source 38 is configured to emit light at intensities of between 700 and 2,000 candelas during normal operating conditions.

The light source 38 can emit light at a range of pulse rates. For instance, the light source 38 can emit (or not emit) constantly (e.g., according to International Civil Aviation Organization (“ICAO”) medium intensity type C (steady burn) style), in rhythmic pulses (e.g., according to ICAO medium intensity type B (flashing) style), such as a 2-second On/1-second Off pulse, or in intermittent pulses, such as a Morse Code signal.

The sectors 42 of the light source 38 can be activated in unison to emit the same signal or independently to emit different signals in direction, color and intensity. The sectors 42 of the light source 38 can be activated in sequence or quasi-sequence to create a rolling wave of light along the array of LEDs. By quasi-sequence, it is meant that the elements of the array of LEDs are illuminated in a periodic sequence, for instance, in the case of a multi-color array of LEDs where adjacent, sequential elements are of different colors and should thus be skipped. By illuminating the sectors 42 of the light source 38 of the beacon 10 in this manner, the beacon 10 mimics a rotating light beacon. The sectors 42 of the light source 38 can be activated at varying levels of intensity, such as a sinusoidal pattern, to smooth the edges of the shifting beam of light emitted by the light source 38.

It should be appreciated that the beacon 10 of the present invention mimics a rotating light beacon without requiring moving parts.

The light source 38 can also be activated selectively to reduce the intensity of transmission in certain directions, which reduces energy consumption and eliminates the need to screen or shield the beacon 10 from emitting light in an undesired direction.

The light source 38 can emit light in any combination of color, intensity, and frequency or pattern, as discussed above, in accordance with the needs of the specific application as regulated by the control unit.

The heatsink 40 is mounted to the lower surface of the top portion 24 of the housing 12 in abutting contact with the light source 38. The heatsink 40 is substantially cup-shaped and has numerous slots and openings formed therein. The base of the cup-shaped heatsink 40 abuts the light source 38, and the walls of the cup-shaped heatsink 40 extend into the top portion 24 of the housing 12. The heatsink 40 disperses heat produced by the light source 38 to other areas of the housing 12, which allows stable, continuous use at ambient temperatures up to 55° C. Preferably, the heatsink 40 is fabricated from extruded aluminum.

It should be appreciated that the heatsink 40 draws heat from the light source 38 away from the light source 38. In particular, the light source 38 is oriented to emit light downward toward the reflector 36 and the heatsink 40 is configured to draw heat upward away from the light source 38 for improved heat transfer relative to known LED beacons.

Preferably, the heatsink 40 secures the light source 38 to the top portion 24 of the housing 12.

Operating at a 2,000 candela intensity level, as defined in FAA Advisory Circular 150/5345-43F, the beacon draws 107 VA or 152.4 VA of electricity from either a 120 V or 220 V utility supply, with tolerances of 93 V to 144 V or 176 V to 250 V, respectively, before the surge protection unit is activated. The beacon 10 consumes between 48 W (low) and 96 W (peak) during ordinary operating conditions, such as at 2,000 candela, with an average of 66 W.

Referring to FIG. 3, a light pattern emitted by a beacon 52 according to one embodiment of the present invention is shown at 54. The beacon 52 is designed for use with airplanes or other vehicles which approach the beacon along a substantially horizontal path. Accordingly, the majority of the light is transmitted substantially horizontally and slightly upward to improve visibility along the approach path of the target vehicle.

The light of the light pattern is generated by a light source 56 and transmitted generally downward therefrom. When the light contacts a reflector 58, the light is reflected outward, through a window 60 and into the surrounding environment. The light is transmitted into the surrounding environment in a substantially horizontal and slightly upward direction.

It should be appreciated that the light pattern of a beacon intended for a different target vehicle can be configured for the needs of that application. For example, a beacon intended for use with helicopters can be oriented substantially upward and slightly horizontally to parallel the approach path of a helicopter toward a helipad. In comparison, a beacon intended for use with boats can be oriented substantially horizontally without significant vertical components.

Referring again to FIG. 1, the housing 12 also includes wired inlets and/or outlets (collectively “ports 62, 64”). The ports 62, 64 include power components, control components or both. The power and control components can be separately or integrated (i.e., a single port receives the control signal over the power signal).

Alternatively, the power inlet and the control inlet can be aligned, grouped or otherwise provided to receive a bundled power and control arrangement for ease of installation. For instance, the ports 62, 64 can be configured to receive a bundled cable pigtail that includes a power line, a data line and an overriding alarm line. Such a bundled cable pigtail might be two (2) meters in length, carry 600 V on the power line and employ a flash data line and a sixteen (16)-gauge wire alarm line.

The housing 12 also has buttons, such as a dimmer button 66. The dimmer button 66 extends through the surface of the housing 12 and can be actuated from outside of the housing 12. A manual actuation of the dimmer button 66, or a remote activation of a dimmer option, reduces the intensity of the light source 38 of the beacon 10 for a period of time before reverting to normal operating conditions. For instance, a single press of the dimmer button 66 reduces the intensity of the light emitted by the light source 38 of the beacon 10 to below 60 candela for 30-minutes.

Preferably, a second press of the dimmer button 66 turns the beacon 10 off, and a third press of the dimmer button 66 returns the beacon 10 to normal operating conditions.

In one embodiment of the present invention, the assembled housing 12, as shown in FIG. 1, provides a secure and resilient casing that does not utilize plastic components. The housing 12 is explosion-proof or, at least, explosion-resistant. The beacon 10 is temperature rated from −55° C. to +55° C. (−67° F. to +131° F.). The beacon 10 weighs approximately 18.6 kg (41 lbs).

Referring to FIG. 4, in harsh environments, the beacon 68 is optionally employed with a heat shield 70. The heat shield 70 insulates the beacon 68 from the harmful effects of a heat source 72, such as a fire or an exhaust port. Preferably, the heat shield 70 is a substantially rectangular plate (e.g., 24 inches by 36 inches) that is positioned in an air space between the beacon 68 and the heat source 70 to maximize its shielding effect. The heat shield 70 limits transmission of heat in accordance with the following test temperatures:

| Heat Source Face | Beacon Face |
|---|---|
| 427° C. (800° F.) | 122° C. (252° F.) |
| 649° C. (1200° F.) | 173° C. (343° F.) |
| 871° C. (1600° F.) | 221° C. (429° F.) |

It should be appreciated that the air between the heat source 72 and the heat sink 70 and the heat sink 70 and the beacon 68 will further limit the heat transmission.

The heat shield 70 is fabricated of a rigid alumina fiber matrix that remains stable for continuous use at upwards of 1720° C. (3128° F.), is not affected by oil or water and is, generally, resistant to chemicals such as acids and alkalis.

Referring to FIG. 5, the control unit, which includes a number of modular subassemblies encased within a housing 74 of a beacon 76, is shown at 78. Traditional beacons that have incandescent light sources are exposed to extreme heat from the operation of the light source. This extreme heat makes it impractical to place electronic circuit elements, such as a control systems, in the housing of the traditional beacon. As a result, it is known to control traditional beacons using a remote control device. There are numerous issues with using a remote control device including increased wiring complexity and signal propagation delay issues that arise over a length of wire connecting the traditional beacon to the remote control device.

Since the beacon 10 of the present invention utilizes an LED light source 38, the temperature in the housing 12 of the beacon 10 are much lower during operation. This lower operating temperature allows circuit elements, such as the control unit 78, to be safely disposed within the housing 12. By placing a control device within the housing 12, the beacon 10 can be controlled more precisely and with less or no reliance upon a wired infrastructure. Additionally, by incorporating the control device into the housing 12, the beacon 10 can have improved operability and functionality relative to known beacons, even when remotely deployed.

The control unit 78 includes a surge protection unit 80, which receives electricity from a utility supply 82 via power inlet 84. The power inlet 84 is accessible through a port of the housing 74.

The surge protection unit 80 includes circuitry, such as metal oxide varistors and gas discharge tubes, to protect all components of the beacon 76 from surges (i.e., over voltage or over current instances), shorts (i.e., short circuit and open circuit instances) and other potentially harmful occurrences. The surge protection unit 80 is designed to withstand defined waveforms, as detailed in Table 4, Location Category C1 of ANSI/IEEE C62.41-1991 “Recommended Practice on Surge Voltages in Low Voltage AC Power Circuits”, which is incorporated herein by reference.

The control unit 78 also includes an input/output line 86 that is run into the housing to a processing unit 88 via the surge protection unit 80. The input/output line 86 receives or transmits a control signal that functionally connects the beacon 10 to another device 90, such as another light emitting device in a chain of light emitting devices or a central control device.

The control unit 78 includes a power supply unit 92 that is connected to the surge protection unit 80.

The control unit 78 includes a backup power supply 94 that is connected to the power supply unit 92 and the processing unit 88. The backup power supply 94, such as a battery and corresponding recharging circuitry, maintains operation of the beacon 76, for instance, in case the utility supply 82 fails (i.e., there is a lack of power at the power inlet) or the surge protection unit 80 is triggered. The backup power supply 94 also enables the beacon 76 to be deployed in a remote location, away from the utility supply 82, where it operates off of DC power, such as a 12 V, 24 V or 48 V battery.

Preferably, the beacon 76 operates using the utility supply 82 during normal operating conditions and the backup power supply 94 is bypassed unless and until the utility supply 82 fails or the surge protection unit 80 is triggered, at which point the beacon 78 seamlessly transitions to the backup power supply 94.

The control unit 78 includes a processing unit 88 that is connected to the power supply unit 72. The processing unit 88 coordinates the other components of the control unit 78 by processing command protocols and directing a control signal (i.e., output) to a light source 96 via a lighting power output 98, such as an electrical signal buffer and interface.

The control unit 78 includes a timer 100 that is connected to the processing unit 88. The timer 100 coordinates the timing of the light source 96 and synchronizes the timing of numerous beacons in the same area.

The control unit 78 is in communication with a wireless GPS transceiver unit that establishes a wireless connection 102 with a satellite 104. The GPS transceiver unit, which includes a GPS control unit 106 and a GPS antenna 108, synchronizes the operation of numerous beacons over a wide area, or within the same area.

It should be appreciated that the GPS transceiver unit can be integrated into the housing 74 of the beacon 76.

The processing unit 88 is connected to buttons 110 mounted to the housing 74, such as a dimmer button.

The control unit 78 also includes a storage unit 112 that is connected to the processing unit 88. The storage unit 112 contains or is configured with programming of operating protocols and operating transmission schemes that the processing unit 88 uses to generate the control signals (i.e., instructions) transmitted to the light source 96. For example, the storage unit 112 can be programmed with any number of modes, including a heliport 3-color flash control mode (“H”); a helipads/airport 2-Color flash control mode (“HA”); a double peak white (MIL) mode (“DP”); or a Morse Code (ICAO) flash control mode (“M”). These modes of operation can be programmed at the time of installation (i.e., initialized or pre-programmed modes) or they may be stored based on a recent command request, such as from the another device 90. The control unit 78 determines which mode to employ from the storage unit 112 and how to instruct the light source 96 based on a variety of inputs, including a command from the another device 90, an input from the button 110, timing inputs from the timer 100 and the GPS transceiver unit, power inputs from the power supply unit 92 and the backup power supply 94 and fault condition inputs from any component of the control unit 76, such as internal sensors (not shown).

A few exemplary modes stored in the storage unit 112 are described immediately hereafter. For example, in a heliport 3-color flash control mode, the control unit 78 instructs the light source 96 to alternately flash white (clear), green and yellow at a rate of 36 flashes per minute, with each color being flashed 12 times per minute. The heliport 3-color flash control mode is intended for use at heliports where an optional visual aid is desired to enhance marking the heliport site location as noted in FAA Advisory Circular 150/5390-2B, paragraph 210.f (2004).

In a heliport/airport 2-color flash control mode, the control unit 78 instructs the light source 96 to flash alternately white (clear) and either green or yellow at a rate of 24 flashes per minute. The heliport/airport 2-color flash control mode is intended for use at general aviation airports or heliports where an optional visual aid is desired to enhance marking the site location.

In a double peak white (MIL) mode, the control unit 78 instructs the light source 96 to flash white (clear) in a double-peaked (i.e., double flash) manner. The double peak white (MIL) mode is intended for military airports or heliports, as indicated in U.S. Military aviation specifications.

In a heliport Morse Code flash control mode, the control unit 78 instructs the light source 96 to transmit a pulsed signal corresponding to a desired Morse Code message. The Morse Code flash control mode complies with ICAO Annex 14, Volume II, paragraph 5.3.2. The Morse Code flash control mode includes numerous sub-modes or instances. In a first (default) instance of the Morse Code flash control mode, the control unit 78 instructs the light source 96 to flash the message “H” in white. Alternatively, for specific national requirements, the beacon color may be green.

In a second (modified default) instance of the Morse Code flash control mode, the user specifies a different message (or messages) for the control unit 78 to instruct the light source 96 to flash at specified transmission color, intensity and frequency. The second instance can be programmed at the factory at the time of assembly. For example, a beacon at a private heliport can be initialized (i.e., programmed at the time of manufacture) to transmit the Morse Code message for “POINT LIGHTING HELIPORT”, or a shorter message such as “PLH”, in order to differentiate one heliport from neighboring heliports. As another example, a beacon at a building rooftop heliport can be initialized to transmit the Morse Code message for “SOS” in the event of an emergency in the underlying building to direct air-born emergency services to the correct heliport.

In addition, upon the identification of a fault or a need for repair, the control unit 78 is placed in a Fault mode. In the Fault mode, the control unit 78 transmits a service message. In addition, the control unit 78 can instruct the light source 96, or as a result of the failure, to turn off. However, since under ICAO it is preferable to have the beacon continue to emit light even in the event of a failure, the control unit 78 can alternatively instruct the light source 96 to remain ON in a diminished output mode, such as at the diminished intensity levels of the dimmer option.

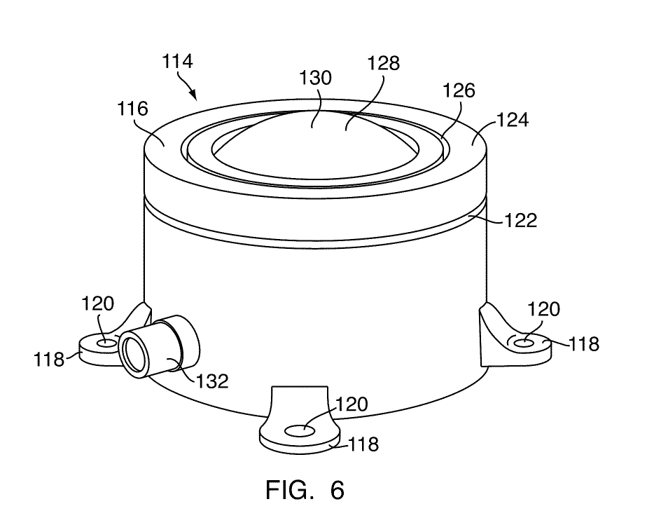

Referring to FIG. 6, a status light or repeater light is shown at 114. The status light 114 is substantially similar to a main beacon, such as beacon 10 shown in FIG. 1, in many ways. For instance, the status light 114 is constructed from the same materials and according to the same standards as the main beacon. However, the status light 114 has a different structure. As shown in FIG. 6, the status light 114 has a substantially cup-shaped housing 116 that includes mounting means about its base, such as protruding tabs 118 with holes 120 formed therein. A top opening 122 of the housing 116 is sealed by a cup-shaped lid 124. The lid 124 includes a central opening 126 for receiving a lens 128. The lens 128 is mounted to the inside of the lid 124, on a side of the lid 124 that faces toward the base of the housing 116. Light is emitted from a light source 130, through the lens 128 and out into the surrounding environment. The status light 114 also includes an input port 132 through which a wired line input (not shown), which includes power and/or control signals, can be inserted.

The status light 114 operates according to similar transmission schemes and modes as the main beacon. However, the status light 114 differs from the main beacon in that each status light 74 is, preferably, associated with a particular main beacon in a master-slave relationship, synchronized with the main beacon, and set to emit at a reduced intensity level. For instance, each status light 114 can be configured to receive and respond to the control signal sent to the associated main beacon. The status light 114 can have limited circuitry to merely operate as a slave unit. The main beacon may be used as a standalone beacon with its associated status light 114 or may be organized in pairs of synchronized status lights 114. The status light 114 may also be used as an optional repeater light installed at the helideck landing surface.

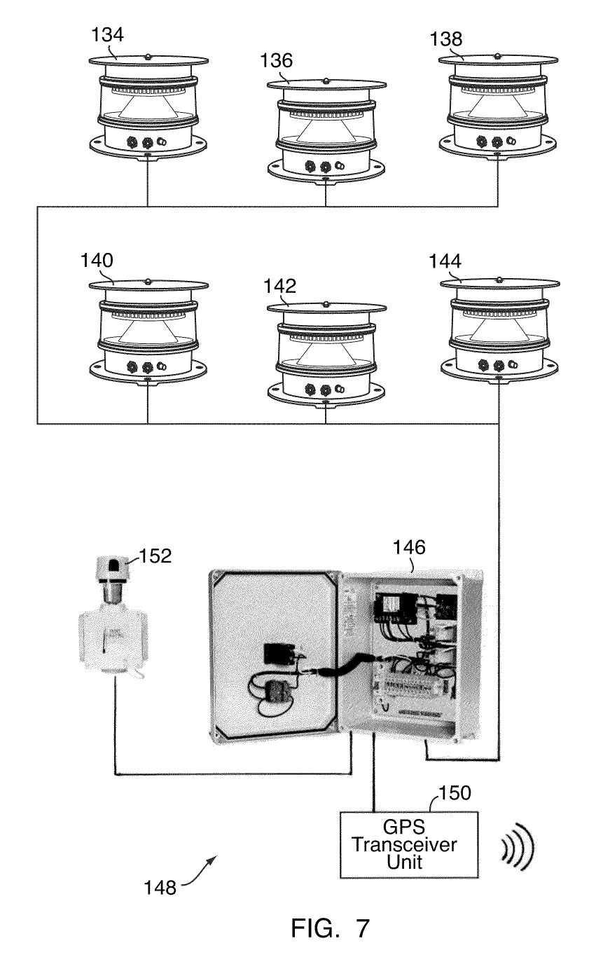

Referring to FIG. 7, a system of beacons 134, 136, 138, 140, 142, 144 in communication with a centralized control device 146 is shown at 148. The centralized control device 148 includes a GPS transceiver unit 150, which coordinates lighting activities of remote lighting systems as discussed above. The centralized control device 148 is connected to a photoelectric controller 152 that wirelessly receives instructions that are then transmitted to the centralized control device 148. The centralized control device 148 relays the instructions to the beacons 134, 136, 138, 140, 142, 144 in the form of control signals. For example, if the system 148 is an obstruction beacon that marks an aviation obstruction, like a tall fence, the instructions may be to separately activate the beacons in groupings, such as a top level of beacons 134, 136, 138 and a middle level of beacons 140, 142, 144.

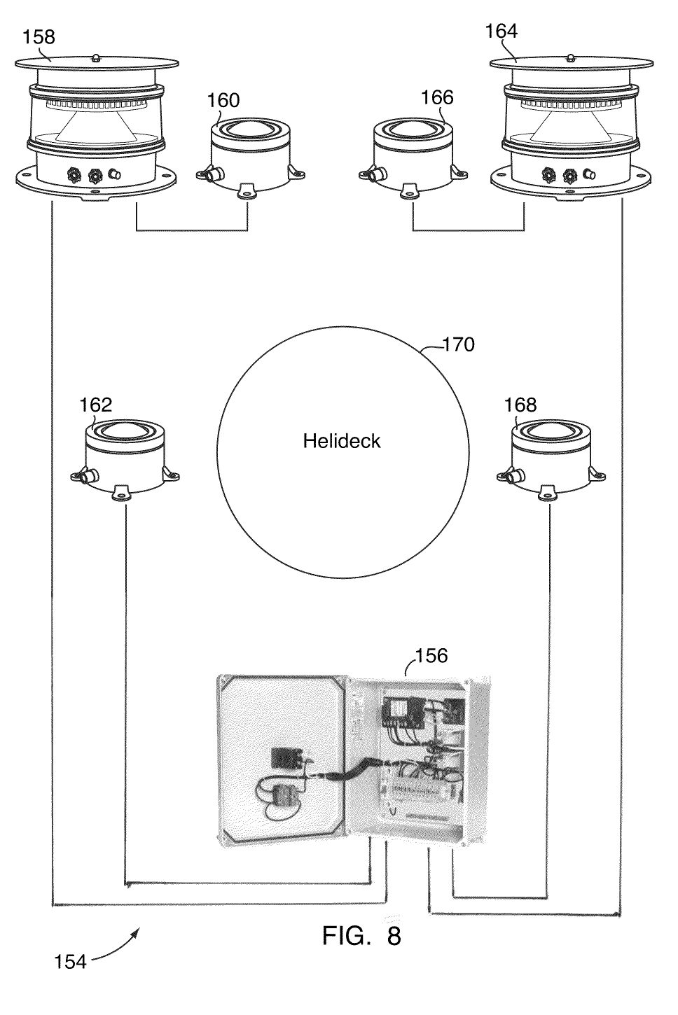

Referring to FIG. 8, a helideck status light system that operates as a non-rotating heliport marker for pilots flashing multiple colors and patterns including Morse Code is shown at 154. The helideck status light system 154 includes another central control device 156 that is connected and transmits instructions to numerous light emitting devices. The light emitting devices include a port beacon 158 with a port status light 160 connected thereto in a master-slave arrangement, another port status light 162, a starboard beacon 164 with a starboard status light 166 connected thereto in a master-slave arrangement, and another starboard status light 168. The light emitting devices are positioned around a helipad 170.

The main beacon and the status light of the present invention are designed and manufactured to satisfy the following compliance standards: ETL Listed to UL 1598 US & CSA C22.2 No.250.0-04 Canada; NEMA 4 Standard for Enclosures for Electrical Equipment; ETL Listed to UL 1598A Marine Vessels; ETL Verified FAA L-864 to FAA Advisory Circular 150/5345-43F, Report No. 3110856CRT-009c; FAA Advisory Circular 150/5390-2B, para. 210.f, 310.h, 410.f; ETL listed to CSA C22.2 No 137-M1981 & No. 250.0-04 Canada; ICAO Annex 14 Medium Intensity Types B & C; ICAO Annex 14, Volume II, para. 5.3.2.1-5, and para. 5.3.3.8-14; UK CAA CAP 437 offshore Helideck status light system; Army™ 5-811-5, para. 7-5.b. Station Identification and para. 7-5.c. Hazard Beacon; Class 1, Division 2, Groups A, B, C, D, T6 (option—EX); Class 1, Zone 2, Groups IIA, IIB+H2, IIC, T6 (option—EX); U.S. Military Standard Salt Fog Test MIL-STD-810E, Method 509.3, Procedure 1; U.S. Army™ 5-811-5, para. 705.c. Hazard Beacon; IP66 ingress protection; U.S. Military method III of TT-C-490 cleaning; U.S. Military method MIL-C-5541 chromate priming; U.S. Military method MIL-PRF-24712A oven cured paint; and U.K. CAA CAP 437 Offshore Helideck Status Light System, each of which is incorporated herein by reference.

It should be understood that the foregoing description is only illustrative of the invention. Various alternatives and modifications can be devised by those skilled in the art without departing from the broader aspects of the present invention.

For instance, in an alternative embodiment, where the use of the beacon is known to be finite (e.g., to transmit only a green light) or somehow limited (e.g., to transmit along less than a full 360° arc), the window can have fixed characteristics. For instance, the window can be provided with a color filter, an opacity limiting filter, or a polarization mechanism. In addition, the window can be provided with a reflective material to act in concert with the reflector assembly by redirecting light into a narrow beam.

In an alternative embodiment, the control unit includes a sound emitting device that emits an auditory warning signal, for instance, to alert a nearby technician that the beacon is in need of repair or servicing.

In an alternative embodiment of the present invention, the network of beacons can take many forms and configurations. The wired communication link can be connected to a centralized control device, for instance, in a command tower.

In an alternative embodiment, the flange of the top portion is configured for mounting additional beacons thereto (i.e., vertically stacked beacons) to achieve higher light intensities and/or for alternative color patterns and flash rates. For instance, the inlet can be positioned on the underside of the flange of the bottom portion with a corresponding extension opening formed in the top of the flange of the top portion, enabling the beacons to plug into one another. The threaded rod can, in turn, be extended to, for instance, double or triple the length of a single-beacon's threaded rod to secure numerous beacons to one another.

What is claimed is:

1. A beacon for a transportation hub or the like, the beacon comprising:
a housing having a window and defining a cavity abutting the window;
a light source mounted in the cavity of the housing, wherein the light source comprises an array of light emitting diodes (LEDs); and
a reflector mounted in the cavity of the housing and positioned to reflect light emitted by the light source toward the window.

2. The beacon according to claim 1, wherein:
the window is tube-shaped and made of a transparent material;
the housing further comprises:
a bottom portion mounted to a lower surface of the window, the bottom portion having a substantially cylindrical shape with a flange formed at a distal end of the bottom portion relative to the window;
a top portion mounted to an upper surface of the window, the top portion having a substantially cylindrical shape with a flange formed at a distal end of the top portion relative to the window; and
the flange of the bottom portion includes mounting means for mounting the beacon to its environment.

3. The beacon according to claim 1, wherein:
the housing defines a longitudinal axis;
the housing is assembled from modular components;
each of the modular components of the housing defines a hole through the longitudinal axis thereof; and
the beacon further comprises:
a threaded rod inserted through the hole of the modular components of the housing; and
an acorn nut secured to the threaded rod; and
the threaded rod and the acorn nut secure the housing in an assembled position.

4. The beacon according to claim 1, wherein:
the housing is assembled from modular components; and
the housing further comprises:
at least one gasket disposed between two of the modular components, the at least one gasket forming a seal therebetween.

5. The beacon according to claim 1, further comprising:
a control unit disposed in the housing;
a port positioned to extend through the housing, wherein the port is electrically connected to the control unit, wherein the port is configured to receive a wired line that carries communication signals to or from another device;
wherein the control unit regulates the operation of the light source based at least in part on a signal received from the another device.

6. The beacon according to claim 1, further comprising:
a control unit disposed in the housing;
a dimmer button positioned to extend through the surface of the housing; wherein:
the dimmer button is electrically connected to the control unit;
the dimmer button is configured to be actuated from outside of the housing; and
the control unit reduces the intensity of the light source for a period of time when the dimmer button is actuated.

7. The beacon according to claim 6, wherein:
the control unit returns the light source to normal operation after the period of time lapses.

8. The beacon according to claim 1, further comprising:
a heatsink disposed in the housing; wherein:
the heatsink abuts the light source; and
the heatsink dissipates heat upward, away from the direction of light emission from the light source.

9. The beacon according to claim 8, wherein:
the heatsink secures the light source to the housing.

10. The beacon according to claim 1, wherein:
the housing defines a longitudinal axis;
the array of LEDs are arranged in an annular pattern centered about the longitudinal axis;
the reflector is centered about the longitudinal axis below and facing the array of LEDs; and
the reflector further comprises:
a substantially conical section body having a surface, the surface having a circular parabolic shape for reflecting light from the array of LEDs in an omnidirectional pattern.

11. The beacon according to claim 1, wherein:
the light source further comprises LEDs of at least two different colors; and
the LEDs of at least two different colors are configured to be separately activated based at least in part on the color of the LEDs.

12. The beacon according to claim 11, wherein:
the LEDs of different colors are arranged in an alternating pattern.

13. The beacon according to claim 1, wherein:
the array of LEDs are formed on a plurality of modular sectors; and
the array of LEDs of each of the plurality of modular sectors are configured to be separately activated.

14. The beacon according to claim 13, wherein:
each of the plurality of modular sectors comprises:
a backing;
at least one electrode mounted to the backing; and
at least one of the array of LEDs is mounted to the backing and electrically connected to the at least one electrode.

15. The beacon according to claim 14, wherein:
the backing defines holes that are used to align the plurality of modular sectors relative to the housing.

16. The beacon according to claim 1, further comprising:
a control unit disposed in the housing and electrically connected to the light source;
wherein the control unit regulates operation of the light source.

17. The beacon according to claim 16, further comprising:
a power inlet positioned to extend through the housing, wherein the power inlet is electrically connected to the control unit;
wherein the control unit further comprises:
a surge protection unit that receives the electrical connection from the power inlet;
a power supply unit that is connected to the surge protection unit; and
a backup power supply that is connected to the power supply;
wherein the light source is powered by the power supply unit or the backup power supply.

18. The beacon according to claim 17, wherein:
the control unit regulates the light source to be powered by the power supply unit unless and until a fault occurs;
the control unit regulates the light source to be powered by the backup power supply once the fault occurs; and
the fault is selected from the group consisting of: a surge, a short, another potentially harmful occurrence, and a lack of power at the power inlet.

19. The beacon according to claim 16, further comprising:
a port positioned to extend through the housing;
wherein the port is electrically connected to the control unit;
wherein the control unit further comprises:
a processing unit that is in communication with another device via the port.

20. The beacon according to claim 19, wherein:
the processing unit regulates operation of the light source based at least in part on a signal received from the another device.

21. The beacon according to claim 19, wherein:
the processing unit transmits a signal to the port, the signal including instructions for how to regulate operation of the another device.

22. The beacon according to claim 16, further comprising:
a global positioning system (GPS) transceiver unit electrically connected to the control unit, wherein the GPS transceiver unit is in wireless communication with a satellite; and
wherein the processing unit regulates operation of the light source based at least in part on a signal received from the GPS transceiver unit.

23. The beacon according to claim 16, wherein:
the control unit further comprises:
a processing unit electrically connected to the light source;
a storage unit in communication with the processing unit;
the storage unit is configured with operating protocols and operating transmission schemes for the light source; and
the processing unit regulates operation of the light source based at least in part on the operating protocols and operating transmission schemes of the storage unit.

24. The beacon according to claim 16, wherein:
the control unit further comprises:
a processing unit electrically connected to the light source;
a timer in communication with the processing unit; and
the processing unit regulates operation of the light source based at least in part on a signal from the timer.

25. The beacon according to claim 16, wherein:
the control unit regulates operation of the light source to mimic a rotating light source;
the light source mimics a rotating light source by varying the intensity of light emitted by the light source from sequential or quasi-sequential elements of the array of LEDs.

26. The beacon according to claim 25, wherein:
the intensity of the light emitted is varied to smooth the edges of the shifting beam of light created by the light source; and
the light source emits a plurality of colors of light.

27. A status light for a transportation hub or the like, the status light comprising:
a cup-shaped housing defining a top opening;
a cup-shaped lid mounted to the housing about the top opening, wherein the lid defines a central opening;
a lens mounted to the central opening of the lid; and
a light source disposed within the housing, wherein the light source comprises an array of light emitting diodes (LEDs).

28. The status light of claim 27, wherein:
the housing further comprises:
a base having a flange that protrudes therefrom and a mounting means;
the flange defines a hole; and
the mounting means is defined in part by the hole of the flange.

29. A light system for a transportation hub or the like, the light system comprising:
two or more beacons according to claim 1;
a centralized control unit in communication with the two or more beacons; and
a wireless transceiver in communication with the central control unit;
wherein the wireless transceiver is selected from the group consisting of: a global positioning system (GPS) transceiver unit and a photoelectric controller unit;
wherein the centralized control unit regulates operation of the two or more beacons based at least in part on a signal from the wireless transceiver.

30. A light system for a transportation hub or the like, the light system comprising:
at least one beacon according to claim 1;
at least one status light, the status light comprising:
a cup-shaped housing having a base that includes mounting means and defining a top opening;
a cup-shaped lid mounted to the housing about the top opening, wherein the lid defines a central opening;
a lens mounted to the central opening of the lid; and
a light source disposed within the housing, wherein the light source comprises an array of light emitting diodes (LEDs); and
a centralized control unit in communication with the at least one beacon and the at least one status light;
wherein the centralized control unit regulates operation of the at least one beacon and the at least one status light.

31. The light system of claim 30, wherein:
one or more of the at least one beacon is connected to one or more of the at least one status light in a master-slave relationship.

32. A beacon for a transportation hub or the like, the beacon comprising:
a control unit; and
an array of light emitting diodes (LEDs) connected to the control unit; wherein:
the control unit regulates operation of the array of LEDs; and
the control unit is configured with programming to instruct the array of LEDs to emit light in Morse Code format.

33. A reflector for a beacon, the reflector comprising:
a substantially conical section body having a surface, the surface having a circular parabolic shape.
